(19) United States
(12) Patent Application Publication
(10) Pub. No.: US 2003/0017371 A1
(43) Pub. Date: Jan. 23, 2003

(54) Method for increasing conductivity of conductive translucent layer

(75) Inventors: Kenneth Burrows, Pilot Point, TX (US); Stuart Ford, Spring, TX (US)

Correspondence Address: VINSON & ELKINS L.L.P., 1001 FANNIN STREET, 2300 FIRST CITY TOWER, HOUSTON, TX, 77002-6760, US

(73) Assignee: E.L. Specialists, Inc., Plano, TX

(21) Appl. No.: 09/886,574

(22) Filed: Jun. 20, 2001

(51) Int. Cl. B32B 9/00; B05D 3/06

(52) U.S. Cl. 428/697; 428/195; 427/558

(57) ABSTRACT

A method for treating a deployed conductive translucent layer that includes exposing the layer to ultra-violet (“UV”) radiation for the design purpose of increasing the conductivity of the layer. The layer advantageously includes a metal oxide dopant such as an indium-tin-oxide. The invention includes exposing the layer to UV radiation both during and/or after curing. The exposure to UV radiation has been shown to increase the conductivity of the layer without appreciably affecting the translucence. In one embodiment, the method includes confining the exposure to UV radiation to preselected zones on the layer so as to create pathways of increased conductivity on the layer.

### TECHNICAL FIELD OF THE INVENTION

This invention relates, in general, to conductive translucent layers (such as are useful, for example, in the manufacture of electroluminescent structures), and more specifically to a method of treating a conductive translucent layer so as to give exceptionally high conductivity to the layer.

### BACKGROUND OF THE INVENTION

Conductive translucent layers are known to be useful, for example, as translucent electrodes in electroluminescent (“EL”) structures. Conductive translucent layers are not limited to EL applications, however, and are also useful, for example, as anti-static layers on other translucent structures and in other applications where electrical conductivity is required in a translucent structure.

Several methods are known for deploying conductive translucent layers. Most involve use of a substrate doped with of a metal oxide dopant such as indium-tin-oxide. Other dopants such as indium-oxide, antimony-based products and mica-based products are also know to be available for similar service.

A traditional method of deploying a conductive translucent layers has been to “sputter” a translucent substrate such as polyester. The sputtering process causes the dopant (generally a metal oxide such as indium-tin-oxide) to dope the surface of the substrate via high-energy impact in an electron field. The sputtering process allows the substrate surface to be impregnated with a thin layer of the dopant. The dopant layer enables conductivity across the substrate while still permitting the sputtered substrate to be translucent.

Another type of conductive translucent layer is disclosed and claimed in co-pending, commonly-owned U.S. patent application TRANSLUCENT LAYER INCLUDING METAL/METAL OXIDE LAYER SUSPENDED IN GEL RESIN, U.S. Ser. No. 09/173,521, now U.S. Pat. No. ______. In U.S. Ser. No. 09/173,521, a translucent conductive layer is deployed in polymer thick film form. A metal oxide dopant such as indium-tin-oxide is disclosed as suspended in a vinyl gel carrier. The suspension is then deployed in layer form as a translucent ink by a process such as screen printing. After curing, the deployed layer has translucent and conductive properties. The layer may deployed directly onto a substrate, or as part of a laminate including other cured ink layers.

In designing translucent conductive layers such as those described immediately above, it will be appreciated that translucence and conductivity are two of the primary variables that will affect the performance of the layer. Conventionally, these variables are considered to be a “trade off.” High conductivity is advantageous to enable translucent conductive layers with low electric power consumption. Conductivity can typically be enhanced by increasing the dopant content deployed, whether by sputtering, ink printing or other methods. Increasing the dopant content tends to reduce the translucence of the deployed layer, however, and often brings additional deployment and performance disadvantages attendant with having a high dopant content in the layer doped on the substrate.

Alternatively, conductivity can be enhanced by deploying additional layers of dopant, or thicker layers of dopant. This adjustment again tends to reduce the translucence of the deployed layer and again brings deployment and performance disadvantages attendant with a physically thick layer.

Thus, in applications where high translucence is desirable (such as EL, for example), conventional technology requires the designer to settle for a translucent layer of lower conductivity. This reduced conductivity causes problems such as high power consumption and heat creation in the deployed layer. These problems become particularly pronounced in applications such as EL where a good current flow is generally desirable to optimize the performance of the electroluminescent content of the structure.

It would therefore be highly advantageous to be able to increase the conductivity of a translucent layer without having to take steps that are known to affect the translucence of the layer. In this way, a layer could be deployed having high translucence (using, for example, low dopant content and/or low layer thickness), while still maintaining high conductivity. Such a highly conductive translucent layer would be able to transmit a high current flow without the traditional disadvantages such as power consumption and heat creation.

### SUMMARY OF THE INVENTION

The present invention fulfils the above-described goals by providing a method for treating a deployed conductive translucent layer for the design purpose of increasing the conductivity thereof, in which the inventive method includes exposing the layer to ultra-violet (“UV”) radiation. The layer advantageously includes a metal oxide dopant such as indium-tin-oxide. The invention includes the option of exposing the layer to UV radiation both during and/or after curing. The exposure to UV radiation has been shown to increase the conductivity of the layer without appreciably affecting the translucence.

Other aspects and features of the invention are described in more detail hereinafter. These include that the enhanced conductivity advantages of the present invention for translucent layers are available for printed ink layers and for sputtered layers. Also, a variety of UV radiation sources are available to enhance conductivity according to the present invention. These sources include mercury UV lamps, in which enhanced conductivity via UV exposure may attained with multiple passes, as well as iron UV lamps, whose higher amplitude and power radiation may often achieve design levels of conductivity in a single uninterrupted burst.

A further aspect of the invention is that exposure to UV radiation may be confined to preselected exposure zones on the layer. This may be achieved by, for example, a stencil or a mask over a “blanket” UV lamp source, or by a UV radiation source with a focused beam such as may be obtained using lenses, mirrors, or via a UV laser. One advantageous result of such selected exposure is that pathways of enhanced conductivity may be created in a translucent layer. In other words, translucent circuitry may be created. The innovation of such translucent circuitry is somewhat enhanced by recognizing that conventionally, as noted above, a highly translucent layer has poor conductivity. Such poor conductivity in zones not treated with UV radiation actually assists the definition of conductive pathways created according to the present invention. Circuitry is thus created with high translucence and with excellent definition of conductive pathways.

It is therefore a technical advantage of the present invention to increase the conductivity of a conductive translucent layer by exposure to UV radiation. Using the present invention, designers may develop conductive translucent layers of high translucence by specifying, for example, low dopant content in a deployed layer, and/or low layer thickness. Such layers would conventionally be expected to have lower conductivity. In accordance with the invention, however, exposure of such layers to UV radiation will increase the conductivity thereof.

A further technical advantage of the present invention is that an increase in the conductivity of a deployed conductive translucent layer can be achieved via exposure to UV radiation both during and/or after curing of the layer. Thus, layers which have already been deployed and cured may gain benefit from the present invention. Alternatively, layers in which UV radiation is also used in the curing process (such as layers of UV-curable inks) may also gain benefit from the invention by attaining higher conductivity during the curing process.

A further technical advantage of the present invention is that a translucent layer may be treated according to the present invention wherein the exposure is confined to preselected exposure zones on the layer. As a result, a translucent layer may be created with, for example, predetermined conductive pathways in the form of translucent circuitry.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a cross-sectional view of a conductive translucent layer deployed according to the present invention directly onto a substrate;

FIG. 2 is a cross-sectional view of an exemplary EL structure including a translucent electrode layer deployed as an embodiment of the present invention;

FIG. 3 indicates the increase in conductivity of an exemplary conductive translucent layer deployed by printing and then exposed to UV radiation according to the present invention;

FIG. 4 indicates the increase in conductivity of an exemplary conductive translucent layer deployed by sputtering and then exposed to UV radiation according to the present invention;

FIG. 5 indicates the increase in conductivity of another exemplary conductive translucent layer deployed by sputtering and then exposed to UV radiation according to the present invention;

FIG. 6 indicates the increase in conductivity of a yet further exemplary conductive translucent layer deployed by sputtering and then exposed to UV radiation according to the present invention; and

FIG. 7 illustrates a conductive translucent layer that has been exposed to UV radiation according to the invention in preselected zones thereof.

### DESCRIPTION OF THE PREFERRED EMBODIMENTS

FIG. 1 illustrates conductive translucent electrode layer 1 deployed on substrate 2. In the embodiment described in detail with reference to FIG. 1, conductive translucent layer 1 is a layer of indium-tin-oxide originally suspended in a vinyl resin gel carrier. In FIG. 1, conductive translucent layer 1 is deployed directly onto substrate 2 using a conventional technique such as screen printing, and is then cured.

As further shown on FIG. 1, conductive translucent layer 1 is also exposed to UV radiation “R”. In accordance with the invention, the exposure to UV radiation R may be during and/or after curing. In the embodiment shown in FIG. 1 in which conductive translucent layer 1 includes a vinyl resin gel carrier, exposure to R will advantageously be after curing since vinyl resins are conventionally heat cured. In other embodiments not illustrated, however, it will be appreciated that conductive layer 1 may alternatively include UV-curable materials, such as a UV-curable urethane carrier. In such other embodiments, it will be understood that the exposure to UV radiation R for the design purpose of increasing conductivity in accordance with the present invention may be done in conjunction with exposure to UV radiation for curing purposes.

Those in the art will understand the inventive distinction between exposure to UV radiation for the design purpose of increasing conductivity of a conductive translucent layer, and exposure to UV radiation for curing purposes. UV radiation is required to cure UV-curable materials (such as UV-curable urethane carriers) that may be used in the deployment of conductive translucent layers. Exposing a conductive translucent layer to UV radiation for the design purpose of increasing its conductivity is nonetheless believed to be inventively distinct regardless of whether UV radiation is already being used to cure the layer. The ability of UV radiation to increase conductivity is an unexpected result addressing a long felt but unsolved need. It will be appreciated that designers of conductive translucent layers that include UV-curable materials will be required to specify UV radiation that satisfies both the curing and conductivity aspects of the design. Typically, according to the invention, designers of conductive translucent layers including UV-curable materials will increase the conductivity thereof by saturating the layer with UV radiation in excess of curing levels.

In yet other embodiments (not illustrated) it will be further appreciated that exposure to UV radiation R for purposes of increasing conductivity may be done during curing even though the conductive translucent layer does not require UV radiation to cure. In these cases, a manufacturing arrangement will advantageously be selected so that exposure to UV radiation R (as illustrated in FIG. 1) is achieved concurrently with the curing process.

It will also be appreciated that when embodied in the treatment of cured inks, the invention is not limited to any particular carrier in which the dopant may suspended before curing. A vinyl carrier has been discussed with reference to FIG. 1, and UV-curable materials such as a UV-curable urethane carrier have also been discussed above. It will nonetheless be understood that a number of different curable carriers may be treated in accordance with the present invention during or after curing. These carriers include vinyl, urethane, polyester, epoxy or acrylic carriers.

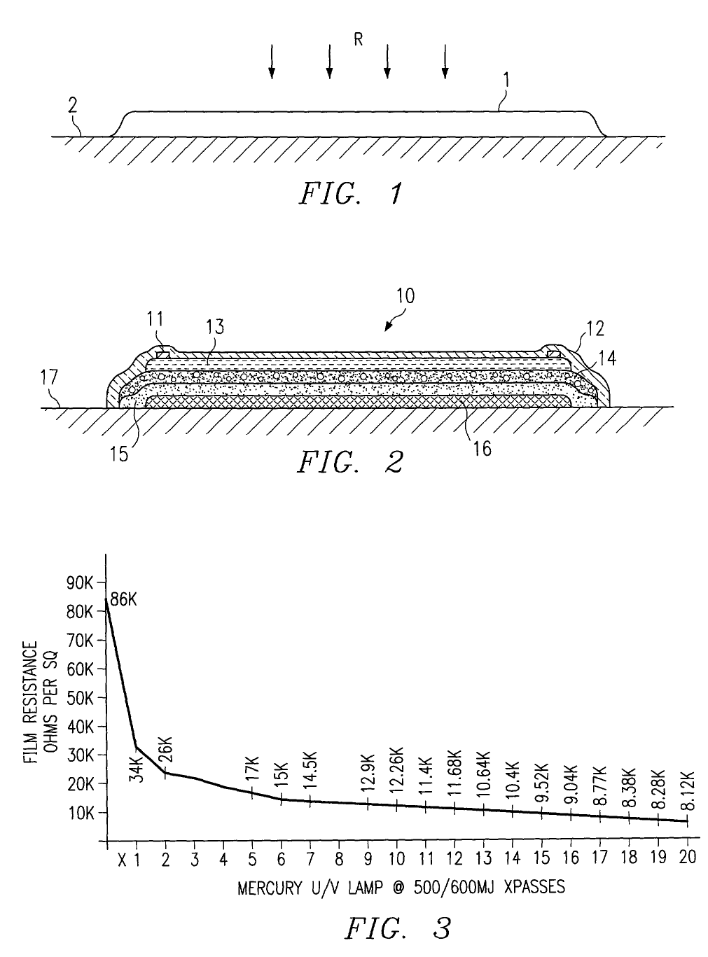

FIG. 2 illustrates a further embodiment of the invention, in which EL structure 10 is a laminate including EL layers 13-16 deployed in cured ink form on substrate 17. In FIG. 2, the layers comprising EL structure 10 are suspensions deployed serially on top of each other. As a lower suspension cures, the layer above is deployed on top. Deployment of the layers is preferably by screen printing, although other conventional methods of deploying suspensions or inks may be used, such as, for example, spraying, brush application, pad printing, carousel printing or roll printing.

In FIG. 2, conductive layer 16 is deployed on substrate 17. Conductive layer 16 preferably includes a suspension doped with a conductive dopant such as silver, copper or graphite. Dielectric layer 15 is then deployed on conductive layer 16. Dielectric layer 15 preferably includes a suspension doped with a dielectric dopant such as barium-titanate. Luminescent layer 14 is then deployed on dielectric layer 15. Luminescent layer 14 preferably includes a suspension doped with a luminescent dopant such as encapsulated phosphor. Translucent electrode layer 13 is then deployed on luminescent layer 14. Translucent electrode layer 13 preferably includes a suspension doped with a metal oxide dopant such as indium-tin-oxide. The various suspensions included in EL layers 13-16 may include dopants suspended in any suitable carrier such as those suggested above, including vinyl, urethane or other carriers known in the art.

With further reference to FIG. 2, bus bar 11 is deployed on translucent electrode layer 13 so as to complete the EL aspect of EL structure 10. Bus bar 11 may be deployed as a conductive strip such as silver or copper, or in the form of another layer of the conductive suspension included in conductive layer 16.

In accordance with the present invention, translucent electrode layer 13 is exposed to UV radiation in the manner described with respect to FIG. 1 for the design purpose of increasing conductivity. Again, exposure to UV radiation may be during or after curing of translucent electrode layer 13. If exposure of translucent electrode layer 13 to UV radiation is selected to be after curing, then such exposure may also be before or after deployment of bus bar 11. It will be noted, however, that if exposure to UV radiation is after deployment of bus bar 11, then translucent electrode 13 may not achieve a full level of increased conductivity in zones that are in the UV radiation “shadow” of bus bar 11. The inventive implications of such a “shadow” are discussed in more detail below in reference to FIG. 7.

Moreover, as discussed already with reference to FIG. 1, if translucent electrode layer 13 includes UV-materials, it will preferably be saturated with UV radiation in excess of curing levels in order to achieve the design purpose of increasing the conductivity thereof.

The remaining layer illustrated on FIG. 2 is protective layer 12. This layer is optional, and, when deployed, it preferably includes a vinyl or a urethane or other material having translucent properties when cured. Protective layer 12 may be deployed by screen printing or any of the other techniques suggested above for deploying other layers in EL structure 10.

The tangible benefits to exposing translucent electrode layer 13 in FIG. 2 to UV radiation in accordance with the present invention include being able to cause EL structure 10 to illuminate with more brightness. EL structure 10 may initially be deployed with translucent electrode layer 13 initially having high translucence, and with attendant low conductivity. The increased conductivity of translucent electrode layer 13 brought about by exposure to UV radiation in accordance with the invention will be seen to permit more electric power to be used to stimulate luminescent layer 14 rather than overcome resistance in translucent electrode layer 13. Luminescent layer 14 will thus tend to shine brighter. Additionally, translucent electrode layer 13 (being initially deployed with high translucence) will tend not to diminish the increased brightness of luminescent layer 14. Other benefits of high translucence and low conductivity in translucent electrode layer 13 will be understood and appreciated by those in the art.

The foregoing description of FIGS. 1 and 2 have referred to exposure to UV radiation to achieve increased conductivity of a conductive translucent layer. Suitable radiation may be derived from any conventional source, such as a mercury UV lamp, an iron UV lamp, a gallium UV lamp, an iridium UV lamp or a UV laser. As will be seen in the discussion below of FIGS. 3 through 6 and the attendant examples, the wavelength and power of a particular UV source is a design variable in development of a specification for achieving desired conductivity in a given construction of a conductive translucent layer. Serviceable results have been achieved by exposure to multiple passes under a mercury UV lamp, often known in the art as an “H” bulb. A suitable mercury UV lamp is manufactured by UVPS, model no.25CC300, specified by the manufacturer as generating UV radiation at wavelengths of approximately 250 nm to 400 nm. Alternatively, serviceable results may also be achieved in comparatively few passes, and even in a single uninterrupted burst, using a UV source with higher amplitude and power. Such UV radiation may be generated by an iron UV lamp, also known in the art as a “D” bulb. A suitable iron UV lamp is manufactured by UVPS, model no. 25CC3001, specified by the manufacturer as generating UV radiation also at wavelengths of approximately 250 nm to 400 nm.

It has been discovered that the use of UV radiation to increase the conductivity of a conductive translucent layer works better with some dopants than others. Indium-tin-oxide and indium-oxide are by far the most common metal oxide dopants used in the prior art for conductive translucent layers. Exposure to UV radiation according to the present invention has been found to work extremely well in increasing the conductivity of conductive translucent layers including an indium-tin-oxide dopant. Indium-oxide may also be expected to work well. On the other hand, exposure to UV radiation appears to have a much less pronounced effect on increasing the conductivity of conductive translucent layers including antimony-based or mica-based dopants.

At this time, the precise reason for the effect of UV radiation lowering conductivity according to the present invention may only be hypothesized. Further work with scanning microscopy may assist further understanding. It is hypothesized that the energy in the UV radiation may enhance electron bonds in the metal oxide as deployed in layer form. It is also hypothesized that the energy in the UV radiation may enhance the electrical pathways between the deployed metal oxide particles, in that the radiation may cause the particles to form additional points of electrical “interconnection.” It is further hypothesized that the energy in the UV radiation may cause some type of transformation or reaction at the electron level within the metal oxide particle lattice. As illustrated on FIGS. 3 through 6, however, it will be appreciated that the process is controllable and predictable with reference to tables and charts. Such tables and charts will advantageously show, for example, previous measurements of increase in conductivity following specific UV radiation exposure to specific constructions and thicknesses of translucent layers. Interpolation and extrapolation using these charted measurements will be seen to enable design of conductive translucent layers to desired specifications.

The present invention has been described above with reference to FIGS. 1 and 2, in which embodiments using conductive translucent layers in cured ink form were exposed to UV radiation for the design purpose of increasing the conductivity thereof. It will nonetheless be appreciated that the invention is not limited to increasing the conductivity of conductive translucent layers deployed in cured ink form. For example, sputtering is a conventional alternative method of deploying a conductive translucent layer. The following examples illustrate the increased conductivity of a cured ink layer and a sputtered layer when exposed to UV radiation in accordance with the present invention.

### EXAMPLE 1

FIG. 3 illustrates the results of an example in which a layer of printed indium-tin-oxide was treated in accordance with the present invention for the design purpose of increasing the conductivity thereof. Indium-tin-oxide in powder form was previously suspended in a vinyl gel carrier, and was then deployed in layer form using a conventional screen printing process onto a polyester substrate. The deployed layer was then cured using heat at about 105 deg F. for 15 minutes.

The indium-tin-oxide powder, available by name from Arconium, contained approximately 99% indium oxide and approximately 1% tin oxide. The carrier was poly vinyl chloride in the form of an electronic vinyl grade resin, available as part no. EL001A from the Acheson Colloids Company. The suspension in the vinyl carrier contained approximately 62 parts dopant to 100 parts carrier by weight.

The deployed layer was approximately 5 microns thick. Two parallel opposing silver bus bars were then screen printed and heat cured (again at about 105 deg F for 15 minutes) to a thickness of approximately 8-10 microns on top of the cured indium-tin-oxide layer. The silver bus bars comprised silver powder suspended in a vinyl carrier, the carrier again being poly vinyl chloride in the form of an electronic grade resin. This silver ink is available pre-mixed from Achesons as part no. EL010, and contains approximately 65-70 parts silver dopant to 100 parts carrier by weight. When cured, the parallel opposing bus bars defined an area approximately 2 inches by 2 inches on the indium-tin-oxide layer. This area was then available for resistance measurement of the cured indium-tin-oxide layer between the bus bars. As can be seen on FIG. 3, the initial measured resistance between the bus bars was 86 k Ohms per square.

The cured indium-tin-oxide layer was then exposed to multiple passes of UV radiation. Each exposure comprised about 3 seconds of approximately 500 mJ of UV radiation at wavelengths of approximately 250 nm to 400 nm, as generated by a mercury UV lamp, or “H” bulb as is known in the art. The UV source was model no. 25CC300 manufactured by UVPS. FIG. 3 depicts the drop in resistance of the defined area of the cured indium-tin-oxide layer after each exposure to UV radiation.

It will be seen from FIG. 3 that after 21 exposures, the resistance of the defined area of the cured indium-tin-oxide layer dropped over 90%, from approximately 86 k Ohms per square to approximately 8.4 k Ohms per square. The translucence of the cured deployed layer nonetheless stayed substantially unchanged throughout the treatment with UV radiation, at a level of about 6-7% light loss through the layer.

### EXAMPLE 2

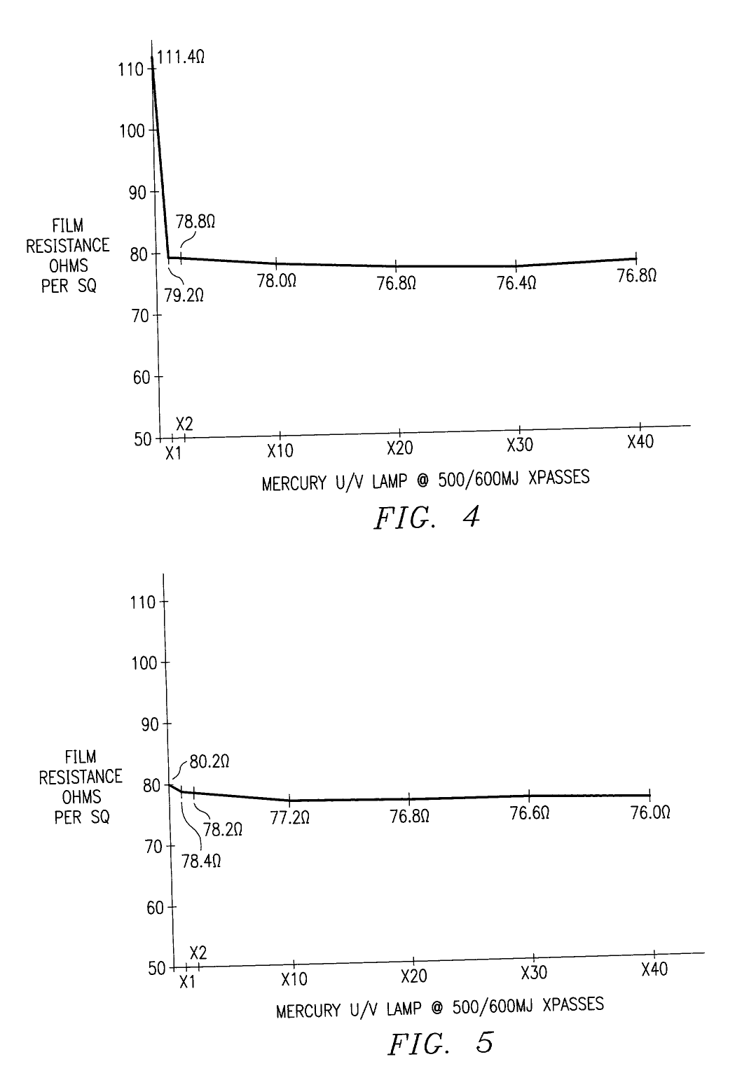

FIG. 4 illustrates the results of an example in which a layer of sputtered indium-tin-oxide was treated in accordance with the present invention for the design purpose of increasing the conductivity thereof. A piece of commercially available sputtered indium-tin-oxide (dopant sputtered by conventional electronic field techniques upon polyester) was obtained from C.P. Films, Inc., part no. OC110. The sputtered layer provided by the manufacturer was less than 1 micron thick.

Two parallel opposing silver bus bars were then screen printed and again heat cured to a thickness of approximately 8-10 microns on top of the sputtered indium-tin-oxide layer in the same manner as described above in Example 1. The silver ink was again part no. EL010 as available pre-mixed from Acheson Colloids Company. Again, when cured, the parallel opposing bus bars defined an area approximately 2 inches by 2 inches on the sputtered indium-tin-oxide layer. This area was then available for resistance measurement of the sputtered indium-tin-oxide layer between the bus bars.

The manufacturer of the sputtered layer rated the resistance of the layer, as manufactured, to be 110 ohms per square. As can be seen on FIG. 4, after deployment and curing of the bus bar layers, the measured initial resistance of the sputtered indium-tin-oxide layer was 111.4 Ohms per square. It should be noted that the sample of sputtered indium-tin-oxide layer used in this Example 2 was taken from the edge of the sheet as manufactured by C. P. Films, Inc. In contrast, in Example 3 described below, the sample of sputtered indium-tin-oxide layer was taken from the center of the sheet, where the initial resistance was considerably lower. It will be understood by those in the art that these differences in the resistance of a sheet of polyester sputtered with indium-tin-oxide are usually caused by the way in which the sheet is manufactured. In particular, the sputtering tends to be more intense and effective away from the edges of the sheet.

Referring again now to FIG. 4 and Example 2, the sputtered indium-tin-oxide layer was then exposed to multiple passes of UV radiation in an analogous protocol to that used in Example 1. Each exposure again comprised about 3 seconds of approximately 500 mJ of UV radiation at wavelengths of approximately 250 nm to 400 nm, as generated by a mercury UV lamp, or “H” bulb as is known in the art. The UV source was model no. 25CC300 manufactured by UVPS. FIG. 4 depicts the drop in resistance of the sputtered indium-tin-oxide layer after each exposure to UV radiation.

It will be seen from FIG. 4 that after 40 exposures, the resistance of the defined area of the cured indium-tin-oxide layer dropped to approximately 77 Ohms per square. This represents approximately a 30% reduction in both the rated and initial measured resistance of the layer. The translucence of the sputtered layer nonetheless stayed substantially unchanged throughout the treatment with UV radiation, at a level of about 10% light loss through the layer.

### EXAMPLE 3

FIG. 5 illustrates the results of an example in which another layer of sputtered indium-tin-oxide was treated in accordance with the present invention for the design purpose of increasing the conductivity thereof. A piece of commercially available sputtered indium-tin-oxide (dopant sputtered by conventional electronic field techniques upon polyester) was obtained from C. P. Films, Inc., part no. OC110. The sputtered layer provided by the manufacturer was less than 1 micron thick.

Two parallel opposing silver bus bars were then screen printed and again heat cured to a thickness of approximately 8-10 microns on top of the sputtered indium-tin-oxide layer in the same manner as described above in Examples 1 and 2. The silver ink was again part no. EL010 as available pre-mixed from Acheson Colloids Company. Again, when cured, the parallel opposing bus bars defined an area approximately 2 inches by 2 inches on the sputtered indium-tin-oxide layer. This area was then available for resistance measurement of the sputtered indium-tin-oxide layer between the bus bars.

The manufacturer of the sputtered layer again rated the resistance of the layer, as manufactured, to be 110 ohms per square. As can be seen on FIG. 5, after deployment and curing of the bus bar layers, the measured initial resistance of the sputtered indium-tin-oxide layer was 80.2 Ohms per square. It should be noted that the sample of sputtered indium-tin-oxide layer used in this Example 3 was taken from the center of the sheet as manufactured by C. P. Films, Inc. In contrast, in Example 2 described above, the sample of sputtered indium-tin-oxide layer was taken from the edge of the sheet, where the initial resistance was considerably higher. It will be understood by those in the art that these differences in the resistance of a sheet of polyester sputtered with indium-tin-oxide are usually caused by the way in which the sheet is manufactured. In particular, the sputtering tends to be more intense and effective away from the edges of the sheet.

Referring again now to FIG. 5 and Example 3, the sputtered indium-tin-oxide layer was then exposed to multiple passes of UV radiation in an analogous protocol to that used in Examples 1 and 2. Each exposure again comprised about 3 seconds of approximately 500 mJ of UV radiation at wavelengths of approximately 250 nm to 400 nm, as generated by a mercury UV lamp, or “H” bulb as is known in the art. The UV source was model no. 25CC300 manufactured by UVPS. FIG. 5 depicts the drop in resistance of the sputtered indium-tin-oxide layer after each exposure to UV radiation.

It will be seen from FIG. 5 that after 40 exposures, the resistance of the defined area of the cured indium-tin-oxide layer dropped to approximately 76 Ohms per square. This represents approximately a 30% reduction in the rated resistance of the layer. This further represents approximately a 5% reduction in the initial measured resistance of the layer. The translucence of the sputtered layer nonetheless again stayed substantially unchanged throughout the treatment with UV radiation, at a level of about 10% light loss through the layer.

### EXAMPLE 4

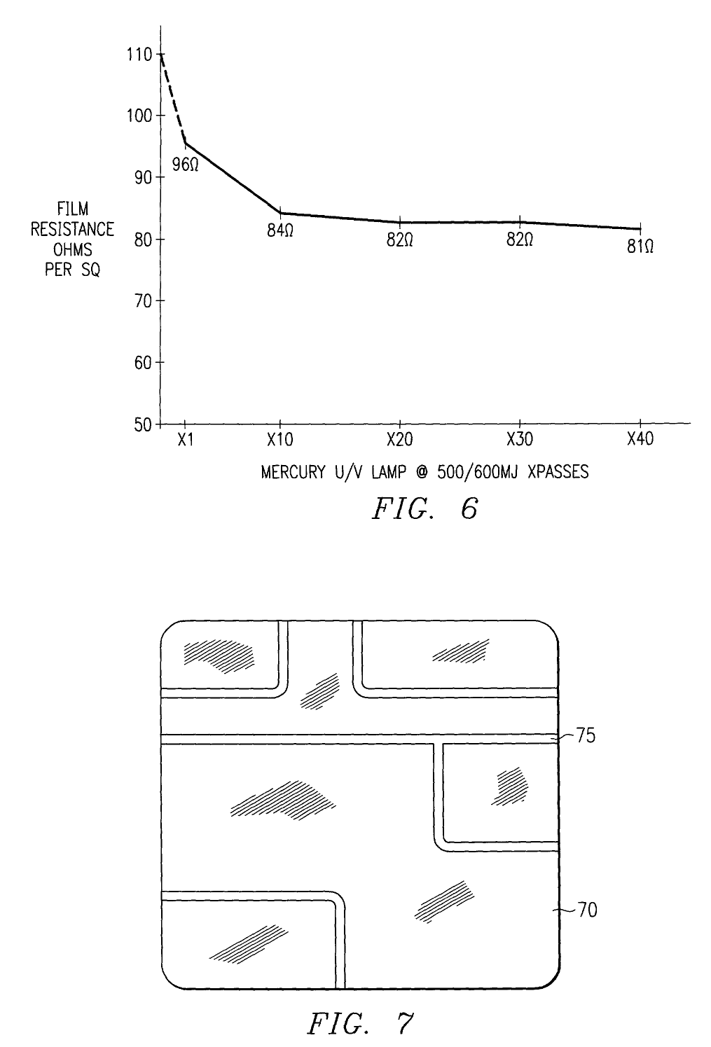

FIG. 6 illustrates the results of an example in which a yet further layer of sputtered indium-tin-oxide was treated in accordance with the present invention for the design purpose of increasing the conductivity thereof. In the case of FIG. 6, however, a UV-curable ink was used to deploy the bus bars.

Analogous to Examples 2 and 3, a piece of commercially available sputtered indium-tin-oxide (dopant sputtered by conventional electronic field techniques upon polyester) was obtained from C. P. Films, Inc., part no. OC110. The sputtered layer provided by the manufacturer was again less than 1 micron thick.

Two parallel opposing silver bus bars were again screen printed to a thickness of approximately 8-10 microns on top of the sputtered indium-tin-oxide layer. In Example 4, however, the silver ink comprised silver powder dopant suspended in a UV-curable urethane. The silver ink used in Example 4 contains approximately 65-70 parts silver to 100 parts carrier by weight, and is commercially available from Allied Photo Chemicals, part no. EXGH-AADS.

The bus bars were cured by exposure to approximately 800 mJ of UV radiation for about 3 seconds. UV radiation was provided at wavelengths of approximately 250 nm to 400 nm, as generated by a mercury UV lamp, or “H” bulb as is known in the art. The UV source was model no. 25CC300 manufactured by UVPS.

Again, when cured, the parallel opposing bus bars defined an area approximately 2 inches by 2 inches on the sputtered indium-tin-oxide layer. This area was then available for resistance measurement of the sputtered indium-tin-oxide layer between the bus bars.

The manufacturer of the sputtered layer rated the resistance of the layer, as manufactured, to be 110 ohms per square. As can be seen on FIG. 6, after deployment and UV-curing of the bus bar layers, the measured initial resistance of the sputtered indium-tin-oxide layer was 96 Ohms per square. It will thus be seen that the UV-curing of the bus bars also achieved the design purpose of increasing the conductivity of the underlying indium-tin-oxide layer, since the UV-curing of the bus bars caused the resistance of the underlying sputtered indium-tin-oxide layer to reduce by approximately 10% from manufacturer's specifications.

The sputtered indium-tin-oxide layer was then exposed to further multiple passes of UV radiation. It will be seen that this additional exposure comprised saturation of the layer with UV in excess of curing levels of at least the bus bars. Each subsequent exposure again comprised about 3 seconds of approximately 500 mJ of UV radiation at wavelengths of approximately 250 nm to 400 nm, as generated by a mercury UV lamp, or “H” bulb as is known in the art. The UV source was model no. 25CC300 manufactured by UVPS. FIG. 6 depicts the drop in resistance of the sputtered indium-tin-oxide layer after each subsequent exposure to UV radiation.

It will be seen from FIG. 6 that after 40 exposures, the resistance of the defined area of the cured indium-tin-oxide layer dropped to approximately 81 Ohms per square. This represents over a 25% reduction in the rated resistance of the layer, and over a 15% reduction in the initial measured resistance of the layer once curing levels of UV radiation for the bus bar had been exceeded. The translucence of the sputtered layer nonetheless stayed substantially unchanged throughout the treatment with UV radiation, at a level of about 10% light loss through the layer.

Turning now to FIG. 7, conductive translucent layer 70 has been deployed on a substrate (not illustrated). In FIG. 7, layer 70 has been treated in accordance with the present invention by confining the exposure to UV radiation to preselected exposure zones 75 on layer 70. As a result, it will be appreciated that exposure zones 75 may now serve as “invisible” conductive pathways on translucent layer 70, and may be used, for example, as circuitry.

Isolation of preselected exposure zones 75 on layer 70 on FIG. 7 may be achieved by, for example, a stencil or a mask over a “blanket” UV lamp source, or by a UV radiation source with a focused beam such as may be obtained using lenses, mirrors, or via a UV laser. Several UV lasers are commercially available. Examples include the following types: HeCd (325 nm); Nitrogen (337.1 nn); XeF and Argon ion (351 nm); Nd-YAG 3rd harmonic (355 nm); Argon ion (364 nm); Alexandrite 2nd harmonic (360-430 nm tunable); Ti-sapphire 2nd harmonic (360-460 nm tunable).

The creation of “invisible” conductive pathways via preselected exposure zones on layer 70 as illustrated on FIG. 7 is believed to be particularly innovative in view of the known properties of traditional conductive translucent layers. As noted above, a highly translucent layer is conventionally recognized as having poor conductivity. If, in FIG. 7, layer 70 is deployed as a highly translucent layer, it will thus be expected that such poor conductivity will exist in those areas on layer 70 that are not exposed to UV radiation. Accordingly, the definition and isolation of conductive pathways created via preselected exposure zones 75 will actually be assisted and enhanced by the poor conductivity of the intervening non-exposed areas. A highly translucent, well-defined piece of circuitry results.

Although the present invention and its advantages have been described in detail, it should be understood that various changes, substitutions and alterations can be made herein without departing from the spirit and scope of the invention as defined by the appended claims.

We claim:

1. A method for treating a deployed conductive translucent layer for the design purpose of increasing the conductivity of the layer, the layer including a metal oxide dopant, the method comprising:
exposing the layer to UV radiation.

2. The method of claim 1, in which the metal oxide dopant is selected from the group consisting of:
(a) indium-tin-oxide; and
(b) indium-oxide.

3. The method of claim 1, in which the conductive translucent layer is included in an electroluminescent laminate.

4. The method of claim 1, in which the conductive translucent layer is deployed using a printing process.

5. The method of claim 1, in which the conductive translucent layer is deployed using a sputtering process.

6. The method of claim 1, in which the layer is exposed to UV radiation from at least one source selected from the group consisting of:
(a) a mercury UV lamp;
(b) an iron UV lamp;
(c) a gallium UV lamp;
(d) an iridium UV lamp; and
(e) a UV laser.

7. The method of claim 1, in which the exposing step further comprises fulfilling the design purpose by exposing the layer to UV radiation in a single uninterrupted burst thereof.

8. The method of claim 1, further comprising:
confining the exposure to UV radiation to preselected exposure zones on the layer.

9. A method for treating a deployed conductive translucent layer for the design purpose of increasing the conductivity of the layer, the layer including a curable carrier in which a metal oxide dopant is suspended, the method comprising:
exposing the layer to UV radiation.

10. The method of claim 9, in which the metal oxide dopant is selected from the group consisting of:

| | |
|---|---|
| (a) | indium-tin-oxide; and |
| (b) | indium-oxide. |

11. The method of claim 9, in which the conductive translucent layer is included in an electroluminescent laminate.

12. The method of claim 9, in which the carrier is selected from the group consisting of:

| | |
|---|---|
| (a) | vinyl; |
| (b) | polyester; |
| (c) | urethane; |
| (d) | epoxy; and |
| (e) | an acrylic carrier. |

13. The method of claim 9, in which the layer is exposed to UV radiation during curing of the carrier.

14. The method of claim 9, in which the layer is exposed to UV radiation after curing of the carrier.

15. The method of claim 9, in which the conductive translucent layer is deployed using a printing process.

16. The method of claim 9, in which the curable carrier is a UV-curable carrier, and in which said exposing step further includes the substep of:
saturating the layer with UV radiation in excess of curing levels.

17. The method of claim 9, in which the layer is exposed to UV radiation from at least one source selected from the group consisting of:

| | |
|---|---|
| (a) | a mercury UV lamp; |
| (b) | an iron UV lamp; |
| (c) | a gallium UV lamp; |
| (d) | an iridium UV lamp; and |
| (e) | a UV laser. |

18. The method of claim 9, in which the exposing step further comprises fulfilling the design purpose by exposing the layer to UV radiation in a single uninterrupted burst thereof.

19. The method of claim 9, further comprising:
confining the exposure to UV radiation to preselected exposure zones on the layer.

20. A method for treating a deployed conductive translucent layer for the design purpose of increasing the conductivity of the layer, the layer including a UV-curable carrier in which a metal oxide dopant is suspended, the method comprising:
saturating the layer with UV radiation in excess of curing levels.

21. The method of claim 20, in which the metal oxide dopant is selected from the group consisting of:

| | |
|---|---|
| (a) | indium-tin-oxide; and |
| (b) | indium-oxide. |

22. The method of claim 20, in which the conductive translucent layer is included in an electroluminescent laminate.

23. The method of claim 20, in which the conductive translucent layer is deployed using a printing process.

24. The method of claim 20, in which the layer is saturated with UV radiation from at least one source selected from the group consisting of:

| | |
|---|---|
| (a) | a mercury UV lamp; |
| (b) | an iron UV lamp; |
| (c) | a gallium UV lamp; |
| (d) | an iridium UV lamp; and |
| (e) | a UV laser. |

25. The method of claim 20, in which the saturating step further comprises fulfilling the design purpose by saturating the layer with UV radiation in a single uninterrupted burst thereof.

26. The method of claim 20, further comprising:
confining the saturation with UV radiation to preselected zones on the layer.

27. A conductive translucent layer, the layer including a metal oxide dopant, the layer treated for the design purpose of increasing the conductivity thereof according to a method comprising:
exposing the layer to UV radiation.

28. The conductive translucent layer of claim 27, in which the metal oxide dopant is selected from the group consisting of:

| | |
|---|---|
| (a) | indium-tin-oxide; and |
| (b) | indium-oxide. |

29. The conductive translucent layer of claim 27, in which the conductive translucent layer is included in an electroluminescent laminate.

30. The conductive translucent layer of claim 27, in which the conductive translucent layer is deployed using a printing process.

31. The conductive translucent layer of claim 27, in which the conductive translucent layer is deployed using a sputtering process.

32. The conductive translucent layer of claim 27, in which the layer is exposed to UV radiation from at least one source selected from the group consisting of:

| | |
|---|---|
| (a) | a mercury UV lamp; |
| (b) | an iron UV lamp; |
| (c) | a gallium UV lamp; |
| (d) | an iridium UV lamp; and |
| (e) | a UV laser. |

33. The conductive translucent layer of claim 27, in which the exposing step in the method further comprises fulfilling the design purpose by exposing the layer to UV radiation in a single uninterrupted burst thereof.

34. The conductive translucent layer of claim 27, in which the method further comprises:
confining the exposure to UV radiation to preselected exposure zones on the layer.

35. A deployed conductive translucent layer, the layer including a curable carrier in which a metal oxide dopant is suspended, the layer treated for the design purpose of increasing the conductivity thereof according to a method comprising:
exposing the layer to UV radiation.

36. The conductive translucent layer of claim 35, in which the metal oxide dopant is selected from the group consisting of:

| | |
|---|---|
| (a) | indium-tin-oxide; and |
| (b) | indium-oxide. |

37. The conductive translucent layer of claim 35, in which the conductive translucent layer is included in an electroluminescent laminate.

38. The conductive translucent layer of claim 35, in which the carrier is selected from the group consisting of:

| | |
|---|---|
| (a) | vinyl; |
| (b) | polyester; |
| (c) | urethane; |
| (d) | epoxy; and |
| (e) | an acrylic carrier. |

39. The conductive translucent layer of claim 35, in which the layer is exposed to UV radiation during curing of the carrier.

40. The conductive translucent layer of claim 35, in which the layer is exposed to UV radiation after curing of the carrier.

41. The conductive translucent layer of claim 35, in which the conductive translucent layer is deployed using a printing process.

42. The conductive translucent layer of claim 35, in which the curable carrier is a UV-curable carrier, and in which said exposing step in the method further includes the substep of:
saturating the layer with UV radiation in excess of curing levels.

43. The conductive translucent layer of claim 35, in which the layer is exposed to UV radiation from at least one source selected from the group consisting of:

| | |
|---|---|
| (a) | a mercury UV lamp; |
| (b) | an iron UV lamp; |
| (c) | a gallium UV lamp; |
| (d) | an iridium UV lamp; and |
| (e) | a UV laser. |

44. The conductive translucent layer of claim 35, in which the exposing step in the method further comprises fulfilling the design purpose by exposing the layer to UV radiation in a single uninterrupted burst thereof.

45. The conductive translucent layer of claim 35 in which the method further comprises:
confining the exposure to UV radiation to preselected exposure zones on the layer.

46. A deployed conductive translucent layer, the layer including a UV-curable carrier in which a metal oxide dopant is suspended, the layer treated for the design purpose of increasing the conductivity thereof according to a method comprising:
saturating the layer with UV radiation in excess of curing levels.

47. The conductive translucent layer of claim 46, in which the metal oxide dopant is selected from the group consisting of:

| | |
|---|---|
| (a) | indium-tin-oxide; and |
| (b) | indium-oxide. |

48. The conductive translucent layer of claim 46, in which the conductive translucent layer is included in an electroluminescent laminate.

49. The conductive translucent layer of claim 46, in which the conductive translucent layer is deployed using a printing process.

50. The conductive translucent layer of claim 46, in which the layer is saturated with UV radiation from at least one source selected from the group consisting of:

| | |
|---|---|
| (a) | a mercury UV lamp; |
| (b) | an iron UV lamp; |
| (c) | a gallium UV lamp; |
| (d) | an iridium UV lamp; and |
| (e) | a UV laser. |

51. The conductive translucent layer of claim 46, in which the saturating step in the method further comprises fulfilling the design purpose by saturating the layer with UV radiation in a single uninterrupted burst thereof.

52. The conductive translucent layer of claim 46 in which the method further comprises:
confining the saturation with UV radiation to preselected zones on the layer.

53. In a deployed conductive translucent layer including a metal oxide dopant, an improved method for treating the layer for the design purpose of increasing the conductivity thereof, the improved method comprising:
exposing the layer to UV radiation.

54. The improved method of claim 53, in which the metal oxide is suspended in a curable carrier.

55. The improved method of claim 54, in which the carrier is a UV-curable carrier, and in which the improved method further comprises:
saturating the layer with UV radiation in excess of curing levels.

56. The improved method of claim 53, in which said exposing step includes fulfilling the design purpose by exposing the layer to UV radiation in a single uninterrupted burst thereof.

57. The improved method of claim 53, further comprising:
confining the exposure to UV radiation to preselected zones on the layer.

58. In a deployed conductive translucent layer including a UV-curable carrier in which a metal oxide dopant suspended, an improved method for treating the layer for the design purpose of increasing the conductivity thereof, the improvement comprising:
saturating the layer with UV radiation in excess of curing levels.

59. The improved method of claim 58, in which said saturation step includes fulfilling the design purpose by saturating the layer with UV radiation in a single uninterrupted burst thereof.

60. The improved method of claim 58, further comprising:
confining the saturation with UV radiation to preselected zones on the layer.
